(19) United States
(12) Patent Application Publication
(10) Pub. No.: US 2024/0092369 A1
(43) Pub. Date: Mar. 21, 2024

(54) CONTEXT AWARE VEHICLE-BASED PROJECTION SYSTEM

(71) Applicant: International Business Machines Corporation, Armonk, NY (US)

(72) Inventors: Tushar Agrawal, West Fargo, ND (US); Martin G. Keen, Cary, NC (US); Jeremy R. Fox, Georgetown, TX (US); Sarbajit K. Rakshit, Kolkata (IN)

(21) Appl. No.: 17/949,709

(22) Filed: Sep. 21, 2022

(51) Int. Cl. B60W 40/09

(52) U.S. Cl. CPC B60W 40/09; B60W 2040/0872; B60W 2540/215

(57) ABSTRACT

A computer-implemented method, in accordance with one embodiment, includes monitoring contextual information of a vehicle during operation thereof. A determination is made that a condition is met to project, by a vehicle-based projection system mounted to the vehicle, a projection indicative of a contextual condition associated with the vehicle. In response to the determination that the condition is met, the projection indicative of the contextual condition is projected.

### BACKGROUND

The present invention relates to vehicle-based projection of visual information, and more specifically, this invention relates to context aware message projection from a vehicle-based projection system.

While a vehicle is running on the road, an occupant (e.g., drive and/or passenger) may be experiencing a problem, condition, or event, and would like to communicate the same to persons outside of the vehicle. However, no systems are currently available for allowing such communication.

### SUMMARY

A computer-implemented method, in accordance with one embodiment, includes monitoring contextual information of a vehicle during operation thereof. A determination is made that a condition is met to project, by a vehicle-based projection system mounted to the vehicle, a projection indicative of a contextual condition associated with the vehicle. In response to the determination that the condition is met, the projection indicative of the contextual condition is projected.

A computer program product for creating a contextually appropriate projection adjacent a vehicle, in accordance with one embodiment, includes one or more computer readable storage media, and program instructions collectively stored on the one or more computer readable storage media, the program instructions to perform the foregoing method.

A vehicle, according to one embodiment, includes a computer, one or more projectors, one or more monitoring devices, and logic integrated with the computer, executable by the computer, or integrated with and executable by the computer. The logic is configured to monitor contextual information of the vehicle during operation thereof. A determination is made that a condition is met to project, by one or more of the projectors, a projection indicative of a contextual condition associated with the vehicle. In response to the determination that the condition is met, the projection indicative of the contextual condition is projected.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a depiction of a vehicle equipped with a vehicle-based projection system configured to provide context aware occupant message projection onto a surface adjacent the vehicle and/or holographically in a vicinity of the vehicle, in accordance with one embodiment.

FIG. 3 is a flowchart of a method, in accordance with one embodiment.

FIG. 4 is a depiction of a vehicle equipped with a vehicle-based projection system configured to provide context aware occupant message projection onto a surface adjacent the vehicle and/or holographically in a vicinity of the vehicle, in accordance with one embodiment.

FIG. 5 is a depiction of a vehicle equipped with a vehicle-based projection system configured to provide context aware occupant message projection onto a surface adjacent the vehicle and/or holographically in a vicinity of the vehicle, in accordance with one embodiment.

FIG. 6 is a flowchart of a method, in accordance with one embodiment.

FIG. 7 is a flowchart of a method, in accordance with one embodiment.

FIG. 8 is a flowchart of a method, in accordance with one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for context aware message projection from a vehicle-based projection system.

In one general embodiment, a computer-implemented method includes monitoring contextual information of a vehicle during operation thereof. A determination is made that a condition is met to project, by a vehicle-based projection system mounted to the vehicle, a projection indicative of a contextual condition associated with the vehicle. In response to the determination that the condition is met, the projection indicative of the contextual condition is projected.

In another general embodiment, a computer program product for creating a contextually appropriate projection adjacent a vehicle includes one or more computer readable storage media, and program instructions collectively stored on the one or more computer readable storage media, the program instructions to perform the foregoing method.

In another general embodiment, a vehicle includes a computer, one or more projectors, one or more monitoring devices, and logic integrated with the computer, executable by the computer, or integrated with and executable by the computer. The logic is configured to monitor contextual information of the vehicle during operation thereof. A determination is made that a condition is met to project, by one or more of the projectors, a projection indicative of a contextual condition associated with the vehicle. In response to the determination that the condition is met, the projection indicative of the contextual condition is projected.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code 150 for context aware occupant message projection from a vehicle-based projection system. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

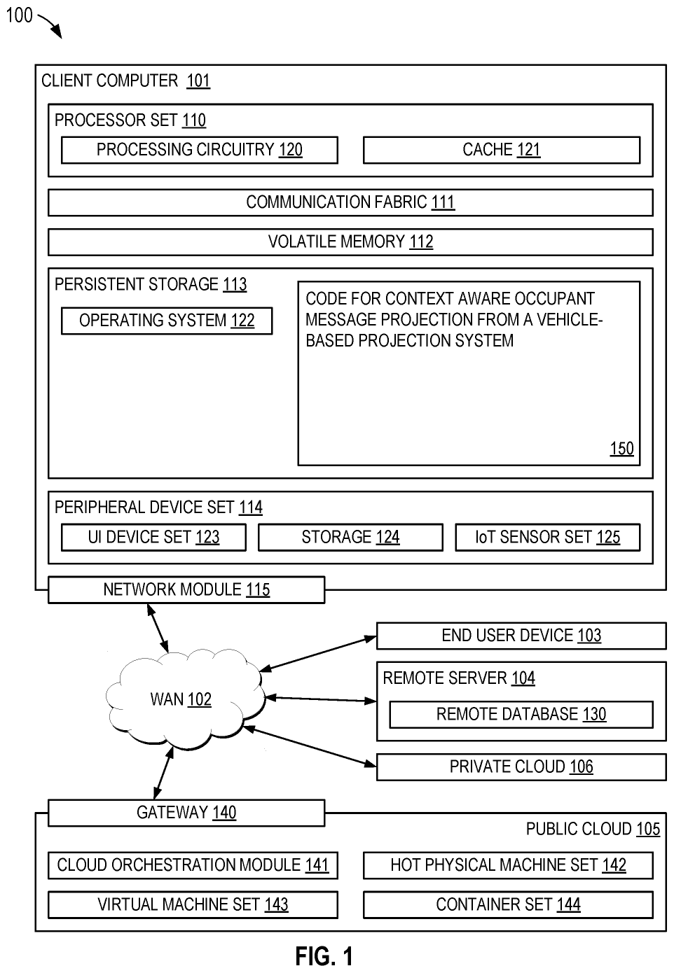

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

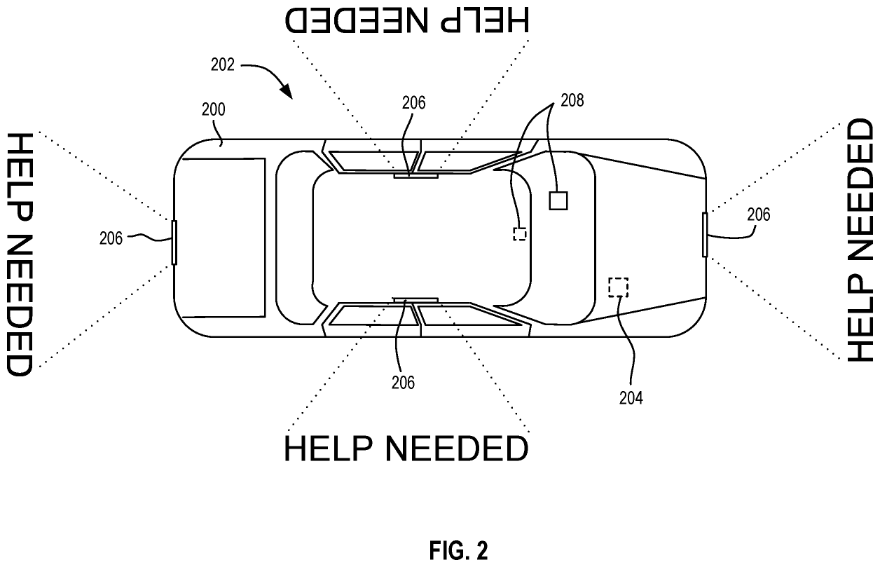

FIG. 2 depicts a vehicle 200 equipped with a vehicle-based projection system 202 configured to provide context aware occupant message projection onto a surface (e.g., roadway, sidewalk, etc.) adjacent the vehicle and/or holographically in a vicinity of the vehicle, in accordance with one embodiment. As an option, the present system 202 may be implemented in conjunction with features from any other embodiment listed herein, such as those described with reference to the other FIGS. Of course, however, such system 202 and others presented herein may be used in various applications and/or in permutations which may or may not be specifically described in the illustrative embodiments listed herein. Further, the system 202 presented herein may be used in any desired environment.

The vehicle may be any type of vehicle, such as an automobile, a truck, a boat, an aircraft, a motorcycle, etc.

The vehicle-based projection system 202 includes several components, such as a computer 204, one or preferably several projectors 206, and one or more monitoring devices 208.

The computer 204 may be any type of processing circuit or subsystem that provides any combination of the functionality described herein. The computer may receive input from the monitoring devices, select content to output based on the input, and control the projectors to output the content.

The projectors 206 may be projectors of any type known in the art. All of the projectors may be of the same type, or multiple different types of projectors may be present on the vehicle. In one approach, one or more of the projectors is laser-based, and is configured to project a projection of words and/or graphics on the surface, e.g., roadway, adjacent the vehicle. In another approach, one or more of the projectors is laser-based, and is configured to project a projection of words and/or graphics in the air adjacent the vehicle, e.g., via the laser light reflecting off of particles, water vapor, etc. in the air. In yet another approach, one or more of the projectors is laser-based, and is configured to project a projection of words and/or graphics on the surface and in the air adjacent the vehicle, selectively and/or simultaneously. In yet another approach, one or more of the projectors is a holographic projector, and is configured to project a holographic word and/or graphic into the air adjacent the vehicle, e.g., via light reflecting off of particles, water vapor, etc. in the air. In some aspects, the distance a projector can project is variable, e.g., can be controlled by the computer depending on the projection, context that caused the system to project a projection, etc.

The projectors may be mounted to the exterior of the vehicle at any appropriate location(s). In FIG. 2, the projectors are shown coupled to the front and back of the vehicle, as well as to the roof of the vehicle above the doors. Each projector is depicted as projecting the phrase “HELP NEEDED” onto the surface adjacent the vehicle. In other approaches, the projectors may be present in the wheel wells, in the doors under the door handles, etc. In further approaches, one or more of the projectors is mounted inside the vehicle, e.g., behind the rearview mirror and/or third brake light, and projects through the glass.

The monitoring devices 208 may be used to create contextual information of the vehicle during operation thereof. Any type of contextual information may be monitored, including any that would become apparent to one skilled in the art after reading the present disclosure. The monitoring may be passive, e.g., the system continuously monitors something to derive contextual information. For instance, with user permission, voice recognition technology of a type known in the art may be used to monitor speech in the vehicle for a phrase or context that matches a condition for creating a projection.

The monitoring may be active, e.g., the system monitors something upon occurrence of a trigger event to derive contextual information. Any type of event that could trigger activation of a monitoring device may be a trigger event. Illustrative trigger events include an explicit instruction from an occupant (e.g., a voice command activation button is pushed by the user), a computer of the vehicle outputs a signal that causes activation of a monitoring device, etc.

The monitoring devices 208 may be of any type known in the art. For example, one or more of the monitoring devices may be configured to receive input from occupants of the vehicle, e.g., verbally, haptically, via touch, etc., and generate corresponding output which is sent to the computer.

One or more of the monitoring devices may be configured to receive input from the vehicle itself, where such input may be reflective of a condition of the vehicle. For example, input may be received from a control system of the vehicle, a tire pressure sensor, a brake system sensor, an engine sensor, etc. In some approaches, the control system of the vehicle may be a monitoring device that provides output to the computer.

One or more of the monitoring devices may be configured to monitor a condition of an environment of the vehicle, such as a toxin detector inside the vehicle, a rain detector, a thermometer, etc.

In addition to those mentioned above, additional illustrative monitoring devices include a microphone, a keypad, a touch screen, a steering wheel mounted interface, a camera positioned to view one or more passengers, a camera positioned to view an environment of the vehicle (e.g., a roadway, other vehicles, etc.), one or more sensors (e.g., a steering wheel-mounted physiology sensor, a brake system sensor, a tire pressure sensor, a rain sensor, etc.), etc. Moreover, the monitoring devices may work together, such as where a steering wheel mounted button is depressed to initiate a listening mode, thereby activating a microphone for receiving spoken content and/or instructions from an occupant of the vehicle.

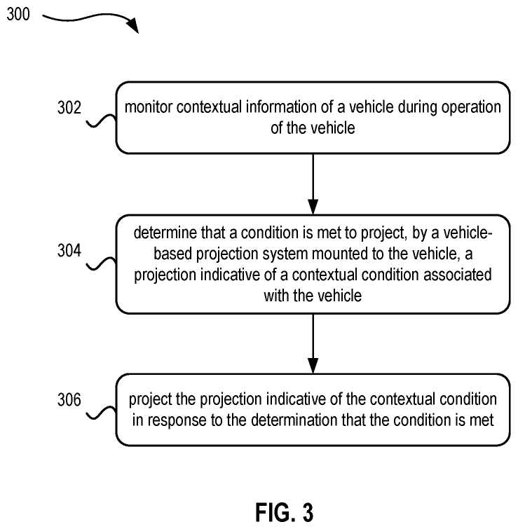

Now referring to FIG. 3, a flowchart of a method 300 is shown according to one embodiment. The method 300 may be performed in accordance with the present invention in any of the environments depicted in FIGS. 1-2, among others, in various embodiments. Of course, more or fewer operations than those specifically described in FIG. 3 may be included in method 300, as would be understood by one of skill in the art upon reading the present descriptions.

Each of the steps of the method 300 may be performed by any suitable component of the operating environment. For example, in various embodiments, the method 300 may be partially or entirely performed by a vehicle-based projection system or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 3, method 300 may initiate with operation 302, where contextual information of a vehicle is monitored during operation of the vehicle. Operation of the vehicle may include driving, idling, stationary with the power system turned on, etc. One or more monitoring devices, such as those mentioned above, may be used to create the contextual information.

As noted above, any type of contextual information may be monitored, e.g., information about the vehicle, an occupant, an environment, etc. For example, monitoring the contextual information may include monitoring a physiology, sounds, and/or actions of an occupant of the vehicle.

In operation 304, a determination is made as to whether a condition is met to project, by a vehicle-based projection system mounted to the vehicle, a projection indicative of a contextual condition associated with the vehicle. The determination may be made in any conceivable manner that would become apparent to one skilled in the after reading the present disclosure. In one approach, the determination may be made at least in part via a comparison of the contextual information to a database, table, etc. of conditions. In a preferred approach, artificial intelligence may be used to determine, based on the contextual information, whether the condition is met. Machine learning may be implemented in some approaches, and may continue to improve the system based on feedback from an occupant.

In operation 306, in response to the determination that the condition is met, the projection indicative of the contextual condition is projected. The projection may include any text and/or graphic relating to the contextual condition in any way. What is projected may be: selected based on the condition that is met, intelligently selected based on the contextual information, a projection pre-associated with a given set of conditions, etc. See the many examples provided herein for illustrative projections.

In one example of use, the contextual information includes input received directly from an occupant of the vehicle, such as the driver. The input may be verbal, tactile, etc. The condition to project may be determined to be met because the occupant overtly instructed the system to generate a projection. In another approach, the condition to project may be determined to be met because the system determines that the input from the occupant meets predefined criteria, such as a spoken word matching a predefined term indicative of the occupant needing help. Continuing with the example, the projection may be manually defined by the occupant. For example, the projection may include text defined by the occupant, such as where the occupant speaks a phrase to project and/or selects a phrase from a menu of phrases.

In one approach, determining that the condition is met includes performing voice recognition on a voice of the occupant, and determining that a result of the voice recognition meets the condition, wherein the projection is indicative of the result of the voice recognition. In the example shown in FIG. 2, the system may detect that an occupant says “project help needed,” upon which the system recognizes speaking of the word “project” as meeting a condition to project and thereafter projects the phrase following “project,” namely “help needed.” This feature may be useful in a situation where a driver or passenger feels unsafe; the occupant can use voice-activated projection to communicate their needs directly to the projection system. The projection system may then project an appropriate message on the road surface for others to see.

In another exemplary approach, a content item (e.g., word and/or graphic) to project may be output to an occupant of the vehicle, such as on an information screen of the vehicle, a heads-up display, audibly via the vehicles audio system, etc. A plurality of options may be offered to the occupant to choose from. Determining that a condition is met to project includes receiving a selection of the content item from the occupant, upon which the selected content item is projected.

In a further illustrative approach, the contextual information received may be indicative of an adverse condition occurring with the driver that could affect the driver's ability to drive and/or that might require medical attention. The system may determine that the adverse condition is occurring, and/or predict that the adverse condition is about to occur, thereby meeting a condition to project a projection. An appropriate projection may then be projected. For example, if the driver is having an adverse health condition such as a heart attack, a fainting spell, etc., a warning and/or request for help may be projected. Examples include text such as “MEDICAL HELP NEEDED” or the like, to notify persons outside the vehicle to seek help for the driver. Note that the driver may be able to stop the vehicle before the system recognizes the adverse condition; the projection may be output around the stopped vehicle to seek help. In another example, if the system detects that driver is beginning to doze off, a safe boundary around the car may be projected to warn pedestrians of the approaching vehicle.

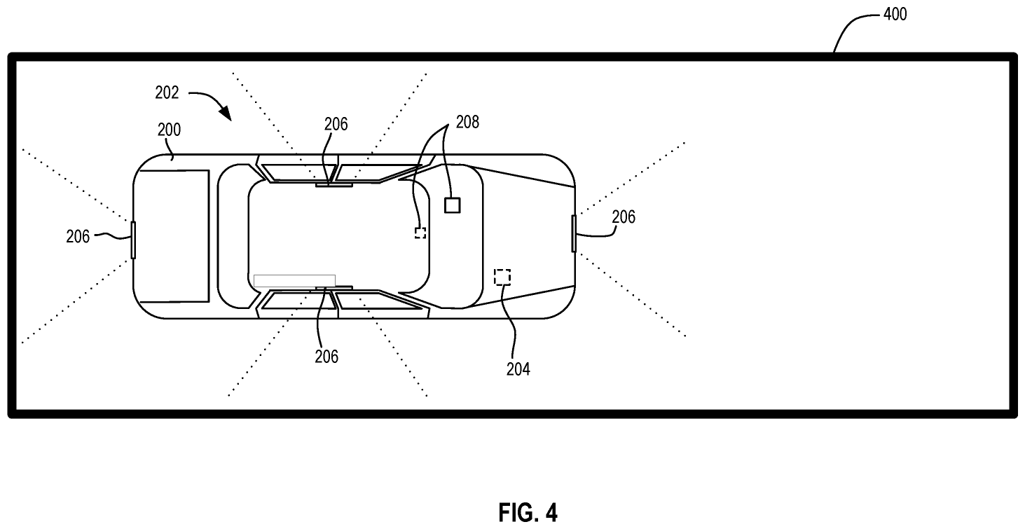

In one exemplary approach, monitoring the contextual information includes monitoring driving behavior of the vehicle. The projection may thus include a graphic (e.g., line, border, etc.) indicating a safe boundary in front of and/or around the vehicle calculated based on the monitored driving behavior. See, e.g., FIG. 4, depicting projection of a boundary 400. For example, the system may analyze the driving behavior of the vehicle to determine a safe boundary for the identified driving pattern, and accordingly, the projection system of the vehicle projects an appropriate boundary around the vehicle so that the other vehicles and/or pedestrians can maintain a safe distance.

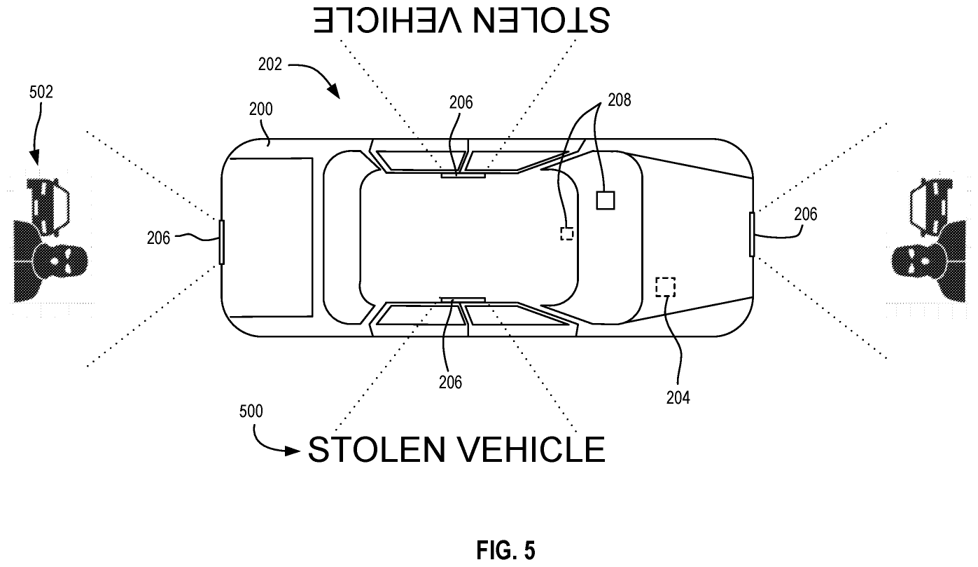

In another exemplary aspect, the determining that the condition is met includes determining that the vehicle is stolen. For example, in the event that the vehicle is determined to be stolen, the projection system of the vehicle may project a projection around the vehicle to notify other people in the surrounding are about the theft of the vehicle. Such projection may include words 500 such as “STOLEN VEHICLE” or the like, a boundary graphic 502, etc. as illustrated in FIG. 5. This will help in prevention of theft by providing a warning to the people nearby. The projection system can also be used to provide contact information for the owner of the vehicle and/or the police so that they can be contacted immediately.

In another illustrative aspect, the contextual information includes vehicle speed and a weather condition. The projection includes an indication of an estimated distance for the vehicle to stop upon application of brakes thereof. For example, the system may evaluate factors such as the vehicle health condition; time and distance required to stop after applying the brakes for various contextual situations such as weather, road condition, vehicle speed, etc.; and accordingly, the proposed system projects a safe boundary around the vehicle, e.g., so that pedestrians and/or other drivers can understand the safe boundary.

In yet another illustrative approach, monitoring the contextual information includes detecting a location of a second vehicle in relation to the vehicle, e.g., using a camera, laser rangefinder, etc. The condition includes the vehicles being closer than a minimum safe distance between the vehicles, e.g., the second vehicle is tailgating the vehicle. Factors such as the speed of the vehicle and/or the second vehicle, estimated minimum stopping time, weather and/or road conditions, etc. may also be factored in to determine the minimum safe distance. The projection may include an indication of the minimum safe distance from the vehicle. The projection may include a graphic such as a line projected onto a roadway behind the vehicle, a boundary around the vehicle, etc. The projection may also and/or alternatively include words such as “TOO CLOSE,” “BACK OFF,” etc.

In a further illustrative approach, monitoring the contextual information includes detecting a weather condition surrounding the vehicle. The condition may include the weather condition matching a predefined condition. The projection includes an indication of a safe boundary around the vehicle, such as a boundary computed based on one or more factors such as the estimated stopping distance of the vehicle in said weather condition.

In yet another illustrative approach, assume the vehicle is traveling on the road and suddenly some or all of the braking system fails. Then, according to the context of the situation, the projection system may project a safe boundary around the vehicle so that persons outside the vehicle are warned and can maintain a safe distance from the moving vehicle.

In a further exemplary approach, the system may analyze the road profile, e.g., as detected by a camera, and may determine that a projector is not able to project a projection onto the roadway, e.g., due to a hill, due to a corner, etc. In response to such a determination, the proposed system may project a hologram into the air, e.g., so that a pedestrian can keep a safe distance from the moving vehicle.

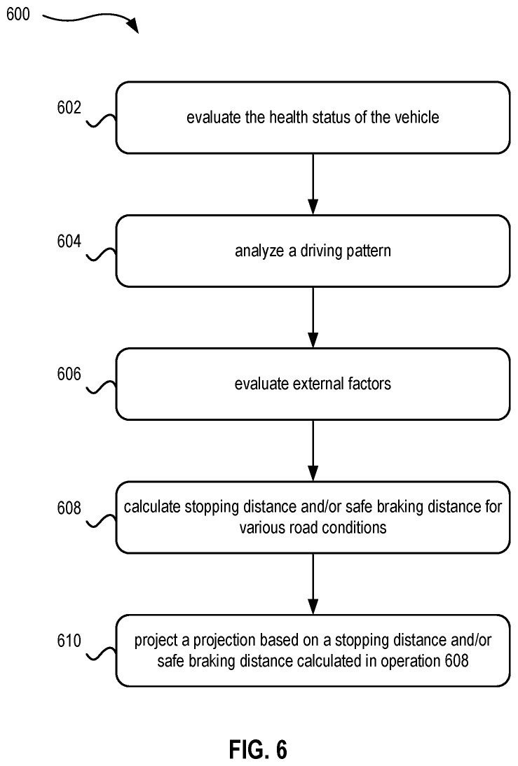

Now referring to FIG. 6, a flowchart of a method 600 for evaluating contextual information is shown according to one embodiment. The method 600 may be performed in accordance with the present invention in any of the environments depicted in FIGS. 1-5, among others, in various embodiments. Of course, more or fewer operations than those specifically described in FIG. 6 may be included in method 600, as would be understood by one of skill in the art upon reading the present descriptions.

Each of the steps of the method 600 may be performed by any suitable component of the operating environment. For example, in various embodiments, the method 600 may be partially or entirely performed by a vehicle-based projection system, or some other device having one or more processors therein. The processor, e.g., processing circuit(s), chip(s), and/or module(s) implemented in hardware and/or software, and preferably having at least one hardware component may be utilized in any device to perform one or more steps of the method 600. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 6, method 600 may initiate with operation 602, where a vehicle-based projection system evaluates the health status of the vehicle. This includes braking capabilities, engine performance, tire pressure, current speed and other vehicle health factors. Preferably, operation 602 is performed once the vehicle-based projection system is powered on, e.g., when the driver turns the key to “on” or to accessory mode.

In operation 604, the system analyzes a driving pattern, e.g., to derive the driving style and skill level of the driver. Information about the driving pattern may be stored for reuse.

In operation 606, the system evaluates external factors such as weather conditions, road conditions, traffic, and other obstructions. Further, the system may evaluate the current context, such as time of day, location, and intended destination.

In operation 608, based upon these vehicle health, derived driver skill, and external conditions, the system continually calculates stopping distance and/or safe braking distance for various road conditions. This may be based, at least in part, on a tire friction coefficient, stopping distances for various environmental factors, etc.

In operation 610, when contextually appropriate, a projection is projected based on a stopping distance and/or safe braking distance calculated in operation 608.

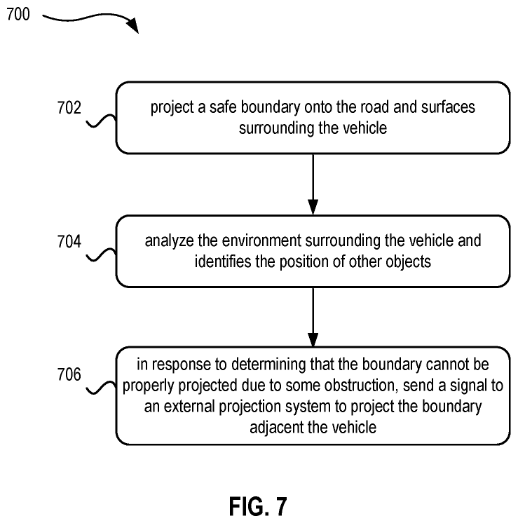

Now referring to FIG. 7, a flowchart of a method 700 for projection by a non-vehicle-mounted projection system is shown according to one embodiment. The method 700 may be performed in accordance with the present invention in any of the environments depicted in FIGS. 1-6, among others, in various embodiments. Of course, more or fewer operations than those specifically described in FIG. 7 may be included in method 700, as would be understood by one of skill in the art upon reading the present descriptions.

Each of the steps of the method 700 may be performed by any suitable component of the operating environment. For example, in various embodiments, the method 700 may be partially or entirely performed by a vehicle-based projection system, or some other device having one or more processors therein. The processor, e.g., processing circuit(s), chip(s), and/or module(s) implemented in hardware and/or software, and preferably having at least one hardware component may be utilized in any device to perform one or more steps of the method 700. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 7, method 700 may initiate with operation 702, in which, when contextually appropriate, the vehicle projection system proactively projects a safe boundary onto the road and surfaces surrounding the vehicle. For example, the projection may be triggered in poor weather conditions, or when another driver is tailgating at an unsafe distance. The projection may also include recognizable icons and/or symbols, preferably ones that are visible in all weather conditions.

In operation 704, a vehicle camera module analyzes the environment surrounding the vehicle and identifies the position of other objects, e.g., vehicles and/or pedestrians, for the purposes of deriving optimal projection.

In operation 706, in response to determining that the boundary cannot be properly projected due to some obstruction (such as trees, poles, or other tall objects), then a signal is sent to an external projection system to project the boundary (or other projection) around as much of the vehicle as possible. The external projection system is not onboard the vehicle, but rather is coupled to an item along a path of travel of the vehicle, e.g., a stop sign, a streetlight, etc. Wireless technology, e.g., cellular phone service, Wi-Fi, etc. may be used to communicate between the vehicle-mounted system and the external projection system.

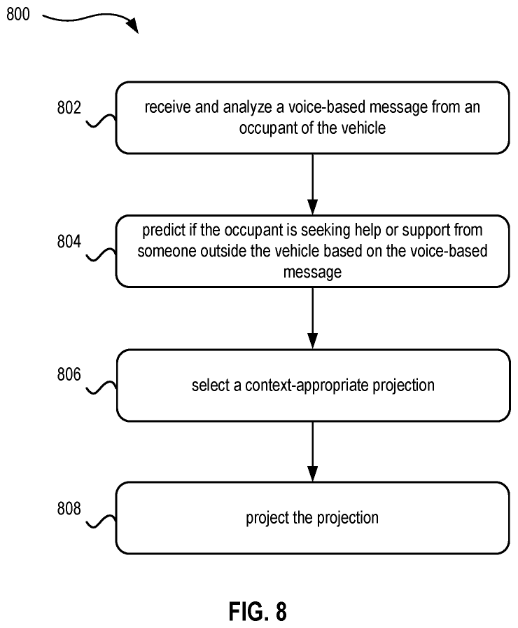

Now referring to FIG. 8, a flowchart of a method 800 for occupant triggered projection is shown according to one embodiment. The method 800 may be performed in accordance with the present invention in any of the environments depicted in FIGS. 1-7, among others, in various embodiments. Of course, more or fewer operations than those specifically described in FIG. 8 may be included in method 800, as would be understood by one of skill in the art upon reading the present descriptions.

Each of the steps of the method 800 may be performed by any suitable component of the operating environment. For example, in various embodiments, the method 800 may be partially or entirely performed by a vehicle-based projection system or some other device having one or more processors therein. The processor, e.g., processing circuit(s), chip(s), and/or module(s) implemented in hardware and/or software, and preferably having at least one hardware component may be utilized in any device to perform one or more steps of the method 800. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 8, method 800 may initiate with operation 802, where a voice-based message from an occupant of the vehicle is received and analyzed. Voice recognition technology may be used.

In operation 804, the system predicts if the occupant is seeking help or support from someone outside the vehicle based on the voice-based message.

In operation 806, a context-appropriate projection is selected. For example, if a change in health status of an occupant is predicted, s projection indicating an emergency may be selected.

In operation 808, the projection is projected, e.g., around the perimeter of the vehicle, preferably with recognizable symbols/icons that are visible in all weather conditions. The projection may include text, and/or may include graphics such as directional arrows. Exemplary text may provide instructions to the driver/passenger, a warning to other drivers of a hazard, or just a generalized message to the public.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
monitoring contextual information of a vehicle during operation thereof;
determining that a condition is met to project, by a vehicle-based projection system mounted to the vehicle, a projection indicative of a contextual condition associated with the vehicle; and
in response to the determination that the condition is met, projecting the projection indicative of the contextual condition.

2. The computer-implemented method of claim 1, wherein the contextual information includes input received directly from an occupant of the vehicle.

3. The computer-implemented method of claim 2, wherein the projection is manually defined by the occupant.

4. The computer-implemented method of claim 3, wherein the projection includes text defined by the occupant.

5. The computer-implemented method of claim 1, wherein monitoring the contextual information includes monitoring a physiology, sounds, and/or actions of an occupant of the vehicle.

6. The computer-implemented method of claim 5, wherein determining that the condition is met includes performing voice recognition on a voice of the occupant, and determining that a result of the voice recognition meets the condition, wherein the projection is indicative of the result of the voice recognition.

7. The computer-implemented method of claim 1, wherein monitoring the contextual information includes monitoring driving behavior of the vehicle, wherein the projection includes an indication of a boundary around the vehicle calculated based on the monitored driving behavior.

8. The computer-implemented method of claim 1, wherein determining that the condition is met includes determining that the vehicle is stolen.

9. The computer-implemented method of claim 1, wherein the contextual information includes vehicle speed and a weather condition, wherein the projection includes an indication of an estimated distance for the vehicle to stop upon application of brakes thereof.

10. The computer-implemented method of claim 1, comprising outputting, to an occupant of the vehicle, a content item to project, wherein determining that a condition is met to project includes receiving a selection of the content item from the occupant, wherein the selected content item is projected.

11. The computer-implemented method of claim 1, wherein monitoring the contextual information includes detecting a location of a second vehicle in relation to the vehicle, wherein the condition includes the vehicles being closer than a minimum safe distance between the vehicles, and wherein the projection includes an indication of the minimum safe distance from the vehicle.

12. The computer-implemented method of claim 1, wherein monitoring the contextual information includes detecting a weather condition surrounding the vehicle, wherein the condition includes the weather condition matching a predefined condition, and wherein the projection includes an indication of a boundary around the vehicle.

13. A computer program product for creating a contextually appropriate projection adjacent a vehicle, the computer program product comprising:
one or more computer readable storage media, and program instructions collectively stored on the one or more computer readable storage media, the program instructions comprising:
program instructions to monitor contextual information of a vehicle during operation thereof;
program instructions to determine that a condition is met to project, by a vehicle-based projection system mounted to the vehicle, a projection indicative of a contextual condition associated with the vehicle; and
program instructions to project the projection indicative of the contextual condition in response to the determination that the condition is met.

14. The computer program product of claim 13, wherein the contextual information includes input received directly from an occupant of the vehicle.

15. The computer program product of claim 13, wherein monitoring the contextual information includes monitoring driving behavior of the vehicle, wherein the projection includes an indication of a boundary around the vehicle calculated based on the monitored driving behavior.

16. The computer program product of claim 13, wherein determining that the condition is met includes determining that the vehicle is stolen.

17. The computer program product of claim 13, wherein the contextual information includes vehicle speed and a weather condition, wherein the projection includes an indication of an estimated distance for the vehicle to stop upon application of brakes thereof.

18. The computer program product of claim 13, comprising program instructions to output, to an occupant of the vehicle, a content item to project, wherein determining that a condition is met to project includes receiving a selection of the content item from the occupant, wherein the selected content item is projected.

19. The computer program product of claim 13, wherein monitoring the contextual information includes detecting a location of a second vehicle in relation to the vehicle, wherein the condition includes the vehicles being closer than a minimum safe distance between the vehicles, and wherein the projection includes an indication of the minimum safe distance from the vehicle.

20. A vehicle, comprising:
a computer;
one or more projectors;
one or more monitoring devices; and
logic integrated with the computer, executable by the computer, or integrated with and executable by the computer, the logic being configured to:
monitor contextual information of the vehicle during operation thereof;
determine that a condition is met to project, by one or more of the projectors, a projection indicative of a contextual condition associated with the vehicle; and
in response to the determination that the condition is met, project the projection indicative of the contextual condition.
